(19) United States
(12) Patent Application Publication
(10) Pub. No.: US 2025/0181316 A1
(43) Pub. Date: Jun. 5, 2025

(54) PROCESSING APPARATUS

(71) Applicant: CANON KABUSHIKI KAISHA, Tokyo (JP)

(72) Inventors: Tsewei CHEN, Tokyo (JP); Masami KATO, Kanagawa (JP); Tadayuki ITO, Kanagawa (JP); Shigeo KODAMA, Tokyo (JP)

(21) Appl. No.: 18/957,998

(22) Filed: Nov. 25, 2024

(30) Foreign Application Priority Data
Dec. 1, 2023 (JP) 2023-204128

(51) Int. Cl. G06F 7/544; G06F 17/15

(52) U.S. Cl. CPC G06F 7/5443; G06F 17/15

(57) ABSTRACT

A processing apparatus is provided. A multiplier circuit sequentially outputs a multiplication result obtained by multiplying each of a plurality of items of data with a corresponding filter weight. An adding circuit adds the multiplication result output by the multiplier circuit with data held in a memory and outputs an adding result. A comparison circuit compares the multiplication result output by the multiplier circuit with the data held in the memory, and outputs one of the multiplication result output by the multiplier circuit and the data held in the memory. A selection circuit outputs, to the memory, one of the output from the adding circuit and the output from the comparison circuit to be held in the memory.

### BACKGROUND OF THE INVENTION

### Field of the Invention

The present invention relates to a processing apparatus, and particularly relates to neural network processing.

### Description of the Related Art

Neural networks, including Convolutional Neural Networks (CNNs), are used for deep learning. Processing in a neural network often includes convolution operations and pooling operations.

There is a need to shorten overall processing time by performing processing in a neural network efficiently. In particular, since many operations are performed in processing using a CNN, improving the efficiency of the operations can be expected to effectively shorten the processing time. There is a particularly urgent need to increase the efficiency of operations when applying a neural network in an embedded system such as a mobile terminal or an in-vehicle device. To that end, improving the efficiency of convolution operations and pooling operations is being considered.

For example, Japanese Patent Laid-Open No. 2020-17281 and Japanese Patent Laid-Open No. 2021-509747 propose configurations that efficiently perform convolution operations and pooling operations by using dedicated hardware or a dedicated circuit. In the method disclosed in Japanese Patent Laid-Open No. 2020-17281, a matrix arithmetic unit performs the convolution operations. A vector calculation unit performs the pooling operations according to a specified stride. Meanwhile, in the method disclosed in Japanese Patent Laid-Open No. 2021-509747, a matrix arithmetic apparatus performs the convolution operations. A pooling unit, which has an aligner that aligns the output of the convolution operations and a pooler that applies pooling operations, performs the pooling operations according to a specified stride.

### SUMMARY OF THE INVENTION

According to an embodiment of the present invention, a processing apparatus comprises: a multiplier circuit configured to sequentially output a multiplication result obtained by multiplying each of a plurality of items of data with a corresponding filter weight; a memory; an adding circuit configured to add the multiplication result output by the multiplier circuit with data held in the memory and output an adding result; a comparison circuit configured to compare the multiplication result output by the multiplier circuit with the data held in the memory, and output one of the multiplication result output by the multiplier circuit and the data held in the memory; and a selection circuit configured to output, to the memory, one of the output from the adding circuit and the output from the comparison circuit to be held in the memory.

According to another embodiment of the present invention, a processing apparatus is configured to be capable of performing convolution operations and pooling operations, the processing apparatus comprising: a setting unit configured to set a plurality of filter weights in accordance with which of the convolution operations or the pooling operations are to be performed; a multiplier circuit configured to sequentially output a multiplication result obtained by multiplying each of a plurality of items of data with a corresponding filter weight; a memory configured to hold data indicating an accumulation result of each of multiplication results output by the multiplier circuit, or a multiplication result selected from the multiplication results; and an output unit configured to output a result of the convolution operation or the pooling operation on the basis of data stored in the memory.

Further features of the present invention will become apparent from the following description of exemplary embodiments (with reference to the attached drawings).

### BRIEF DESCRIPTION OF THE DRAWINGS

FIGS. 1A and 1B are flowcharts illustrating processing in a neural network according to one embodiment.

FIG. 2 is a diagram illustrating an example of the structure of a neural network.

FIG. 3 is a block diagram illustrating an example of the hardware configuration of an information processing apparatus according to one embodiment.

FIG. 4 is a block diagram illustrating an example of the configuration of a convolution operation unit according to one embodiment.

FIG. 5 is a block diagram illustrating an example of the configuration of an adding/comparison processing unit according to one embodiment.

FIG. 6 is a diagram illustrating a relationship between a neural network and convolution operations.

FIGS. 7A to 7C are diagrams illustrating an example of peak detection processing.

FIG. 8 is a flowchart illustrating post-processing according to one embodiment.

FIG. 9 is a diagram illustrating an example of the structure of a network for post-processing.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The methods described in Japanese Patent Laid-Open No. 2020-17281 and Japanese Patent Laid-Open No. 2021-509747 require two types of dedicated circuits, including a dedicated circuit that performs convolution operations and a dedicated circuit that performs pooling operations. However, the circuit that performs the pooling operations has different configuration from the circuit that performs the convolution operations, which makes it necessary to increase the scale of the circuit. As such, the methods described in Japanese Patent Laid-Open No. 2020-17281 and Japanese Patent Laid-Open No. 2021-509747 have a problem in that the scale of the hardware circuit used for the processing is large.

One embodiment of the present invention makes it possible, in neural network processing, to perform convolution operations and pooling operations efficiently while suppressing an increase in the scale of the circuit that performs that processing.

### Example Of Configuration Of Data Parallel Processing Apparatus

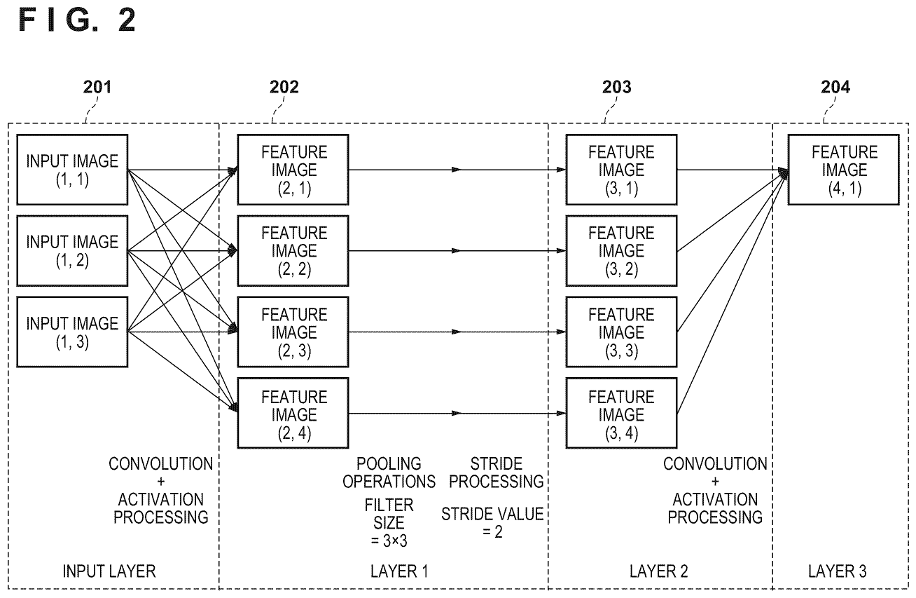

FIG. 3 is a block diagram illustrating the configuration of an information processing apparatus according to one embodiment of the present invention. Note that the information processing apparatus may include various constituent elements aside from those described below, but descriptions thereof will be omitted here.

An input unit 301 obtains instructions or data from a user. The input unit 301 can be a keyboard, a pointing device, buttons, or the like, for example.

A data storage unit 302 is a recording medium that stores data. The data storage unit 302 can store image data, programs, or other data. The data storage unit 302 can be a hard disk, a flexible disk, a CD-ROM, a CD-R, a DVD, a memory card, a CF card, SmartMedia, an SD card, a Memory Stick, an xD-Picture Card, a USB memory, or the like, for example. Part of a RAM 308 (described later) may be used as the data storage unit 302.

A display unit 304 displays images. The display unit 304 can display images from before or after image processing, or images such as a GUI. The display unit 304 can be a CRT, a liquid crystal display, or the like.

The display unit 304 and the input unit 301 may be implemented by the same device. For example, a touchscreen device can be used as the display unit 304 and the input unit 301. In this case, inputs made on the touchscreen can be handled as inputs made to the input unit 301.

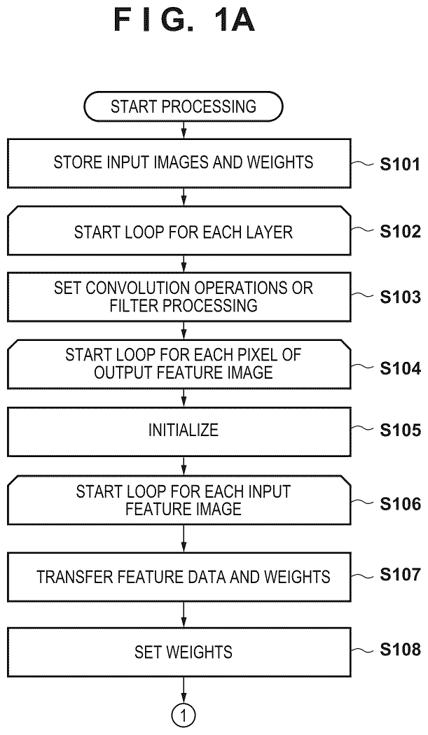

A convolution operation unit 305 performs convolution operations (described later). For example, the convolution operations can be performed on images stored in the RAM 308. Specifically, the convolution operation unit 305 can perform processing (steps S101 to S114) according to the flowcharts illustrated in FIGS. 1A and 1B (described later). In other words, the convolution operation unit 305 can perform convolutional neural network processing including multiply-accumulate operations on results of the image processing stored in the RAM 308. The convolution operation unit 305 outputs results obtained from the processing to the data storage unit 302 (or the RAM 308). The convolution operation unit 305 can function as a convolution operation apparatus according to one embodiment. Note that the information processing apparatus may include a plurality of convolution operation units 305 in order to perform processing in the neural network in parallel.

A CPU 306 controls the operations of the apparatus as a whole. Note that FIG. 3 illustrates a configuration in which the information processing apparatus has only one CPU (the CPU 306). However, the information processing apparatus may include a plurality of CPUs, GPUs (Graphics Processing Units), NPUs (Neural Processing Units), or the like.

AROM 307 and the RAM 308 provide, to the CPU 306, programs, data, work areas, and the like necessary for processing. If a program is stored in the data storage unit 302 or the ROM 307, the program is temporarily loaded into the RAM 308. The program in the RAM 308 is then executed. The information processing apparatus may also receive a program through a communication unit 303. In this case, the program is loaded into the RAM 308 after being recorded into the data storage unit 302. Alternatively, the program is loaded directly into the RAM 308 from the communication unit 303.

The CPU 306 can also generate a result of image processing or image recognition on the basis of the result of the processing performed by the convolution operation unit 305. In one embodiment, the convolution operation unit 305 outputs a confidence map expressing a certainty that an object to be detected is present at each of positions or regions in an input image. In this case, the CPU 306 can generate and output information indicating the position of a specific subject in the image in accordance with the confidence map. For example, the CPU 306 can determine that the subject is present at a position of a peak value in the confidence map. The CPU 306 can then superimpose information indicating the position of the determined subject on the input image.

Note that the convolution operation unit 305 may perform processing on each of a plurality of frames of a moving image. In this case, the CPU 306 can generate a result of image processing or image recognition for the moving image.

The CPU 306 can store the result of the image processing or the image recognition in the RAM 308.

An image processing unit 309 performs image processing on an image. For example, the image processing unit 309 can perform image processing on image data written into the data storage unit 302 and write a result thereof into the RAM 308 in response to a command received from the CPU 306. The type of the image processing is not limited. The image processing may be, for example, pixel value range adjustment processing.

The communication unit 303 is an interface for communicating among devices. FIG. 3 illustrates the information processing apparatus as including various elements such as the input unit 301, the data storage unit 302, and the display unit 304. However, each of these elements may be connected over a communication path. For example, the display unit 304 may be a display device outside the information processing apparatus, and connected by a cable or the like. The data storage unit 302 may also be configured virtually. For example, a storage device connected via the communication unit 303 may be used as the data storage unit 302. In this manner, the information processing apparatus according to one embodiment is constituted by a plurality of devices connected over a communication path.

### Network for Processing

As described above, the information processing apparatus according to the present embodiment can perform the processing in a neural network. The neural network can include layers in which convolution operations are performed and layers in which pooling operations are performed. In one embodiment, the neural network is a CNN.

In the processing in the neural network, a convolution operation using filter weights (coefficients) determined through learning and pixel values of a feature image (feature data) is performed for each of spatial local areas (windows). The convolution operation is a multiply-accumulate operation, and includes a plurality of multiplication operations and accumulation operations.

Pooling operations are also performed in the processing in the neural network. The pooling operation is processing for outputting a representative value (maximum values, minimum values, average values, and the like) for each spatial local area (window). A stride is a parameter of the pooling operations, and indicates a movement range of the window. If the stride is 2, the feature image is reduced to half the size in both the vertical direction and the horizontal direction by the pooling operations.

To that end, the information processing apparatus can include or function as a convolution operation apparatus. The convolution operation apparatus can perform convolution operations and pooling operations on images.

In the present embodiment, the pooling operations according to any desired stride as described above are realized by a combination of filter processing and stride processing. In the filter processing, a representative value for each window is calculated by applying a filter. A feature image obtained through the filter processing has the representative values calculated in this manner as feature data for each pixel. In the present embodiment, the stride of the filter processing is 1. A maximum value filter, a minimum value filter, an average value filter, or the like can be used as the filter. The filter processing corresponds to pooling operations in which the stride is 1. As will be described later, the convolution operation apparatus can perform two or more types of pooling operations.

Meanwhile, in the stride processing, the image is reduced in accordance with a predetermined stride. Specifically, a part of the feature data constituting the feature image is extracted at an interval according to the stride. The stride processing corresponds to pooling operations in which the window size is 1×1. In addition, the stride processing corresponds to pooling operations that uses the value at a predetermined position in the window as the representative value. When the stride is 1, the feature image is the same before and after the stride processing. In the present embodiment, the stride of the stride processing may be greater than 1. In addition, the stride of the stride processing can be set independent of the window size in the pooling operations. In other words, the stride of the stride processing may be different from the window size in the pooling operations (or the filter processing).

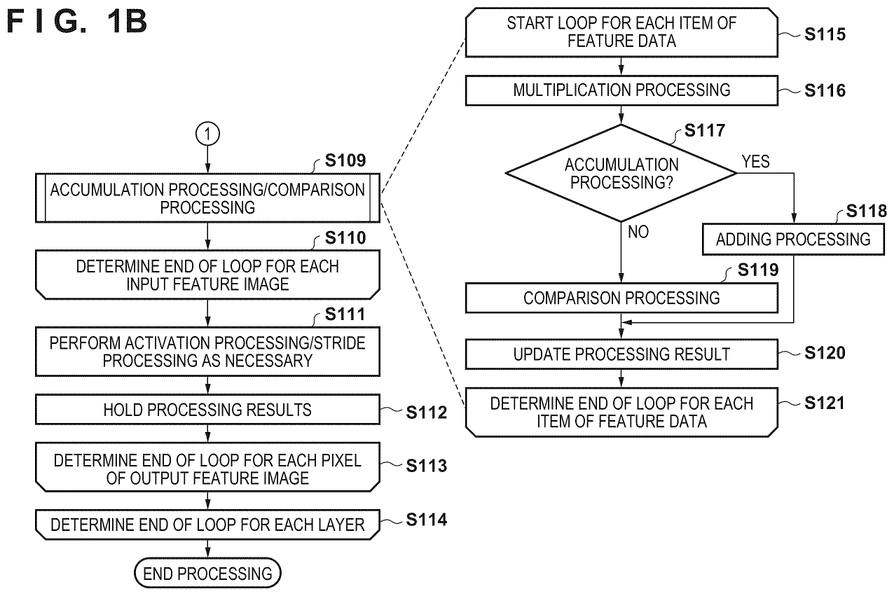

FIG. 2 illustrates an example of a CNN used by the convolution operation apparatus according to one embodiment. In this CNN, a plurality of layers are connected hierarchically. The filters and the plurality of items of feature data are also configured hierarchically. As illustrated in FIG. 2, the network structure of the neural network is defined by the information of each layer (connection relationships between layers, filter structures, bit widths of the weights, size of the feature image, bit width, number of images, and the like). In the example illustrated in FIG. 2, the number of layers is 4 (an input layer and layers 1 to 3). Additionally, each layer includes one or more feature images. Specifically, layers 1 and 2 have four feature images. Layer 3 has one feature image. A single feature image contains a plurality of items of feature data. The plurality of feature images correspond to a plurality of channels.

The network illustrated in FIG. 2 outputs a confidence map expressing a certainty that an object to be detected is present at each of positions or regions in the input image (a feature image 204). In the input layer, a multiply-accumulate operation is performed using a plurality of input images 201 and weights according to Formula (1). In this manner, a plurality of feature images 202 for layer 1 are generated. Three input images are input to the input layer. The three input images correspond to an R (red), G (green), and B (blue) channel, respectively.

In layer 1, filter processing is performed using the plurality of feature images 202 in accordance with Formula (2). In this example, the window size (filter size) is 3×3. In layer 1, the stride processing is further performed according to Formula (4). In this manner, a plurality of feature images 203 for layer 2 are generated. In this example, the stride is 2. The size of each feature image 203 (number of pixels) is ¼ that from before the stride processing. The combination of the processing for layer 1 and the processing for layer 2 corresponds to pooling operations. However, the window size in the pooling operations is not limited to 3×3. The window size in the pooling operations can be any desired size. Additionally, the stride of the pooling operations is not limited to 2. The stride can be any desired positive integer.

In layer 2, a multiply-accumulate operation is performed using the plurality of feature images 203 and weights according to Formula (1). In this manner, the feature image 204 for layer 3 is generated.

As described above, the feature image of a current layer is generated by convolution operations using the feature images from the previous layer and the weights corresponding to the previous layer. The plurality of feature images from the previous layer are used to generate a single feature image in the current layer. Formula (1) indicates an example of a formula for the convolution operations.

$${O}_{i , j} ( n ) = {\sum }_{m = 1}^{M} {\sum }_{x = 0}^{X - 1} {\sum }_{y = 0}^{Y - 1} ( {I}_{i - \frac{X - 1}{2} + x , j - \frac{Y - 1}{2} + y} ( m ) \times {C}_{x , y} ( m , n ) ) \qquad ( 1 )$$

In Formula (1), the variable n represents the number of the feature image of the current layer. The variable m represents the number of the feature image in the previous layer. The previous layer has M feature images. I(m) represents the mth feature image. The window size used in the convolution operations is X×Y There are X×Y weights (C_{0,0}(m, n) to C_{X-1,Y-1}(m, n)), and the weights may differ for each combination of the numbers m, n of the feature images. In this example, the variables X and Y are odd. The number of multiplications in the multiply-accumulate operation for computing the feature data for one pixel of the feature image in the current layer is M×X×Y O_{i,j}(n) is the result of the multiply-accumulate operation result for a pixel (i, j) in the feature image. The variable i, j indicates the coordinates of a pixel in the feature image.

Formulas (2) and (3) indicate an example of formulas for the filter processing. Formula (2) represents the filter processing for maximum pooling operations (max pooling). Formula (3) represents the filter processing for average pooling operations (average pooling).

$${O}_{i , j}^{′} ( n ) = {max}_{0 \leq x < X} {max}_{0 \leq y < Y} ( {I}_{i - \frac{X - 1}{2} + x , j - \frac{Y - 1}{2} + y} ( n ) ) \qquad ( 2 )$$

$${O}_{i , j}^{′} ( n ) = \frac{1}{X Y} {\sum }_{x = 0}^{X - 1} {\sum }_{y = 0}^{Y - 1} ( {I}_{i - \frac{X - 1}{2} + x , j - \frac{Y - 1}{2} + y} ( n ) ) \qquad ( 3 )$$

Formula (4) indicates an example of a formula for the stride processing.

$${O}_{i , j}^{″} ( m ) = {O}_{R \times i , R \times j}^{′} ( m ) \qquad ( 4 )$$

The variable R represents the stride, and is a positive integer. If the variable R is greater than 1, the stride processing corresponds to a type of downsampling. The variable R corresponds to the rate of the downsampling. The size (number of pixels) of the feature image after the stride processing is 1/(R×R) the size of the feature image from before the processing.

In processing performed in a neural network, after performing the convolution operations or the filter processing, it is possible to perform activation processing, the filter processing, the stride processing, or the like on the basis of the network structure. For example, activation processing can be further performed on the processing results obtained as described above. In the above example, the feature images of layers 1 and 3 are generated by performing activation processing on a result O_{i,j}(n) of the multiply-accumulate operation. The pixel (i, j) in the nth feature image may have feature data obtained by activation processing performed on the result O_{i,j}(n) of the multiply-accumulate operation.

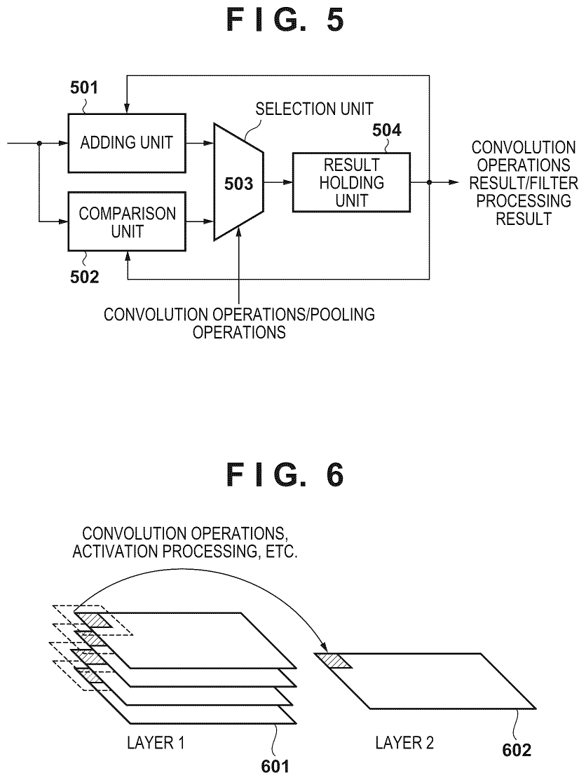

FIG. 6 illustrates an example of the convolution operations. Convolution operations are performed on the feature data extracted from the same position in four feature images 601 in layer 2. Activation processing is performed on the multiply-accumulate operation result obtained from the convolution operations. The result of the activation processing is used as feature data for the same position in a feature image 602 in layer 3.

Such neural network learning can be performed on the basis of error between (i) the output of the neural network in response to an input image for learning and (ii) a corresponding labeled image. Error back propagation can be given as a specific learning method. An image in which pixel values are set according to a Gaussian distribution centered on the position of an object to be detected in the input image for learning can be used as the labeled image.

### Configuration of Convolution Processing Unit

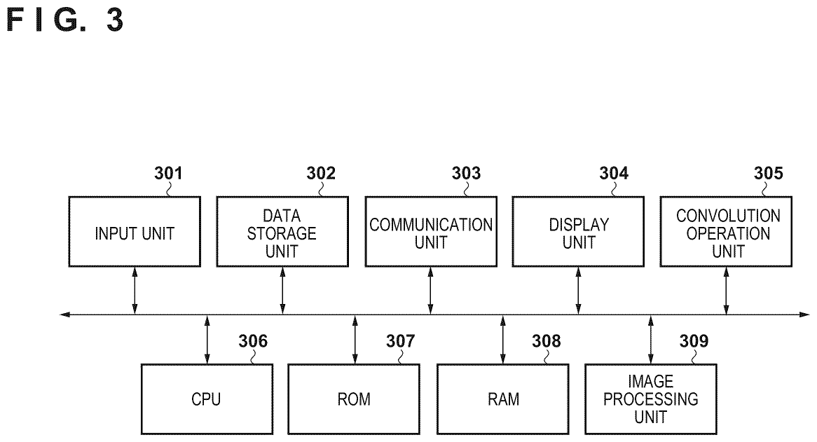

FIG. 4 illustrates an example of the configuration of the convolution operation unit 305. The convolution operation unit 305 includes a controller 401, a feature data holding unit 402, a filter weight holding unit 404, a filter weight setting unit 405, a multiplication processing unit 406, and an adding/comparison processing unit 403. The convolution operation unit 305 may also include an activation/stride processing unit 407 and a data holding unit 408. Note that the convolution operation unit 305 may include a plurality of multiplication processing units 406 and a plurality of adding/comparison processing units 403 for parallel processing. The number of each of the other processing units is also not limited to one.

The controller 401 controls the overall operations of the convolution operation unit 305. The controller 401 may include, for example, a CPU, a sequencer, an ASIC, or an FPGA for control. On the other hand, the functions of the controller 401 may be implemented by the CPU 306.

The data holding unit 408 temporarily holds feature images, weights, and network structure information. For example, the data holding unit 408 can hold one or more feature images and weights used in the convolution operations. The data holding unit 408 is a memory, for example. However, the RAM 308 or the data storage unit 302 may be used as the data holding unit 408.

The filter weight holding unit 404 temporarily holds the weights used in the convolution operations. For example, the filter weight holding unit 404 can read out, from the data holding unit 408, and hold a weight C_{x,y}(m, n) used in the multiply-accumulate operation for calculating the feature data for one pixel of the nth feature image in the current layer. x and y indicate relative pixel positions in the window of the convolution operations or filter processing. The filter weight holding unit 404 is a memory such as a DRAM, an SRAM, registers, flip-flops, or latches, for example.

The feature data holding unit 402 temporarily holds at least a part of the feature image subject to the convolution operations or the filter processing. The feature data holding unit 402 can read out, from the data holding unit 408, and hold at least a part of the feature data of a feature image I(m) of the previous layer. The feature data holding unit 402 may hold the feature data of each pixel in the window of the convolution operations or filter processing. The feature data holding unit 402 is a memory such as a DRAM or an SRAM, for example.

The filter weight setting unit 405, the multiplication processing unit 406, and the adding/comparison processing unit 403 calculate the results of the convolution operations or filter processing.

The filter weight setting unit 405 sets a plurality of filter weights used by the multiplication processing unit 406. Here, the filter weight setting unit 405 can set filter weights corresponding to each of a plurality of items of data, according to whether to perform the convolution operation or the pooling operations. In one embodiment, the filter weight setting unit 405 adjusts the weight C_{x,y}(m, n) held by the filter weight holding unit 404. When performing convolution operations, the weights are the same before and after the adjustment. In this case, the weights may differ according to the values of x and y. Additionally, when performing the pooling operations, the adjusted weights differ depending on the type of the pooling operations. The weights are set such that the multiplication processing unit 406 can perform the calculation in the same manner as in the convolution operations. When performing the pooling operations, the filter weight setting unit 405 can set constant weights regardless of the values of x and y. For example, when performing max pooling, the weights may be set to 1. The filter weight setting unit 405 may include a CPU, an ASIC, or an FPGA for processing. On the other hand, the functions of the filter weight setting unit 405 may be implemented by the controller 401 or the CPU 306.

The multiplication processing unit 406 sequentially outputs results of multiplying each of the plurality of items of data with a corresponding filter weight. The plurality of items of data can be feature data of a plurality of pixels in the window of the convolution operations or filter processing in the feature image I(m) of the previous layer. Accordingly, the multiplication processing unit 406 can sequentially output results of multiplying each of the plurality of items of data included in the window of the convolution operations or the pooling operations set in the image with a corresponding filter weight. Specifically, the multiplication processing unit 406 outputs the results of multiplying these items of data with the corresponding weights C_{x,y}(m, n) for each of different combinations of x and y. In the present embodiment, the multiplication processing unit 406 is hardware for performing computations. The multiplication processing unit 406 may be referred to herein as a “multiplier circuit”.

The adding/comparison processing unit 403 integrates the multiplication results sequentially output by the multiplication processing unit 406, or selects one of the multiplication results sequentially output by the multiplication processing unit 406, in accordance with a control signal from the controller 401.

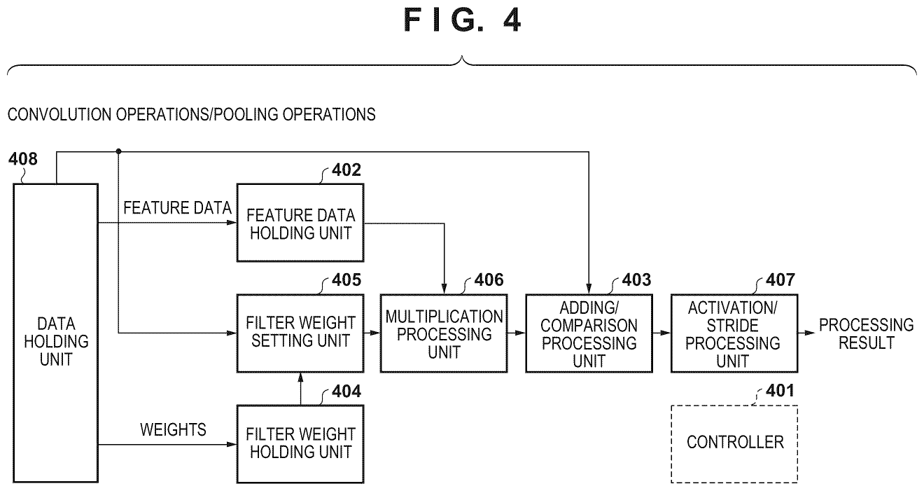

FIG. 5 illustrates an example of the configuration of the adding/comparison processing unit 403. The adding/comparison processing unit 403 includes an adding unit 501, a comparison unit 502, a selection unit 503, and a result holding unit 504. The adding unit 501 adds the multiplication result output by the multiplication processing unit 406 with the data held by the result holding unit 504, and outputs an adding result. In the present embodiment, the adding unit 501 is hardware for performing computations. The adding unit 501 may be referred to herein as an “adding circuit”.

The comparison unit 502 compares the multiplication result output by the multiplication processing unit 406 with the data held by the result holding unit 504. The comparison unit 502 then outputs the multiplication result output by the multiplication processing unit 406 or the data held by the result holding unit 504.

For example, the comparison unit 502 can compare the output of the multiplication processing unit 406 with the output of the result holding unit 504, and output the larger (or smaller) thereof. In the present embodiment, the comparison unit 502 is hardware for performing computations. The comparison unit 502 may be referred to herein as a “comparison circuit”.

The selection unit 503 outputs the output of the adding unit 501 or the output of the comparison unit 502 to the result holding unit 504 so as to be held by the result holding unit 504. In this manner, the selection unit 503 can select the output of the adding unit 501 or the output of the comparison unit 502. The selection unit 503 can select the output of the adding unit 501 or the comparison unit 502 according to control by the controller 401. For example, the controller 401 can control the selection operations by the selection unit 503 in accordance with the network structure information. In other words, the selection unit 503 can output, to the result holding unit 504, the output of the adding unit 501 or the output of the comparison unit 502, selected for each layer in the neural network. The selection unit 503 can also output, to the result holding unit 504, the output of the adding unit 501 or the output of the comparison unit 502, selected in accordance with the type of processing performed in the layer. Specifically, when performing the convolution operations or average pooling, the selection unit 503 selects the output of the adding unit 501. In other cases (e.g., when performing max pooling), the selection unit 503 selects the output of the comparison unit 502. In the present embodiment, the selection unit 503 is hardware for performing computations. The selection unit 503 may be referred to herein as a “selection circuit”.

The result holding unit 504 is a memory. The result holding unit 504 can hold the output of the adding unit 501 or the output of the comparison unit 502 selected by the selection unit 503. As described above, the result holding unit 504 can output the held data to the adding unit 501 and the comparison unit 502.

According to the configuration described above, the selection unit 503 repeats the operation of outputting the output of the adding unit 501 or the output of the comparison unit 502 to the result holding unit 504, for each of the plurality of items of data to be processed by the multiplication processing unit 406. After this processing, the data held by the result holding unit 504 is the result of the convolution operation or the result of the filter processing for the pooling operation. Accordingly, the data held by the result holding unit 504 is output as a result of processing the plurality of items of data. In this manner, the data output from the result holding unit 504 corresponds to pixel data of an image indicating the result of the convolution operation or filter processing on the image of the previous layer.

For example, if the selection unit 503 selects the output of the adding unit 501, the adding unit 501 adds the multiplication results sequentially output by the multiplication processing unit 406 to the data held by the result holding unit 504. In this manner, the adding/comparison processing unit 403 can perform an accumulation operation. The data ultimately held by the result holding unit 504 is the accumulation result of the respective multiplication results output by the multiplication processing unit 406. The result holding unit 504 can therefore output the result of the convolution operations. Additionally, by setting the weights appropriately, the adding/comparison processing unit 403 can output an average of the plurality of multiplication results.

On the other hand, if the selection unit 503 selects the output of the comparison unit 502, the result holding unit 504 stores the multiplication result selected from the multiplication results sequentially output by the multiplication processing unit 406. For example, if the comparison unit 502 outputs the larger of the two outputs, the result holding unit 504 stores the maximum of the multiplication results sequentially output by the multiplication processing unit 406. In this manner, the result holding unit 504 can output the maximum of the plurality of multiplication results. In other words, the result holding unit 504 can output the result of max filtering for the max pooling.

In this manner, in one embodiment, the result holding unit 504 can hold the result of the convolution operations while also holding the result of the filter processing for the pooling operations. As such, according to the present embodiment, the same memory that holds the result of the convolution operations can be used as the memory that holds the result of the filter processing for the pooling operations. The circuit scale of the convolution operation unit 305 and the result holding unit 504 can therefore be suppressed.

Additionally, in the present embodiment, the adding/comparison processing unit 403 can perform filter processing for max pooling or average pooling in the same manner as the convolution operations. The maximum window size for the pooling operations can therefore be made the same as the maximum window size of the convolution operations. For example, if the maximum value for the window size X×Y in the convolution operations is 7×7, the maximum value for the window size X×Y in the pooling operations can also be set to 7×7. In one embodiment, the size of the window when performing the pooling operations is greater than 1×1. In this manner, pooling operations according to the various window sizes can be performed, and thus the flexibility of the pooling operations using the convolution operation unit 305 can be increased. Furthermore, in the present embodiment, the filter processing and the stride processing are performed separately for the pooling operations. Accordingly, the window size and the stride of the pooling operations performed by the convolution operation unit 305 can be set separately. In this manner, the convolution operation unit 305 can handle processing using networks having various structures.

The activation/stride processing unit 407 performs activation processing or stride processing. The activation/stride processing unit 407 can perform activation processing on the data output by the adding/comparison processing unit 403 (i.e., the data held by the result holding unit 504). For example, the activation/stride processing unit 407 can perform activation processing on the result of the convolution operations output by the adding/comparison processing unit 403. The activation/stride processing unit 407 can also perform stride processing on the result of the comparison processing output by the adding/comparison processing unit 403, without performing activation processing.

Additionally, the activation/stride processing unit 407 can perform stride processing on the data output by the adding/comparison processing unit 403 (i.e., the data held by the result holding unit 504). For example, the activation/stride processing unit 407 can perform stride processing on the result of the filter processing output by the adding/comparison processing unit 403. As described above, the data output from the result holding unit 504 corresponds to pixel data of an image indicating the result of the convolution operations or filter processing on the image of the previous layer. According to the stride processing, a part of the data output from the result holding unit 504 is extracted such that the image is reduced according to the predetermined stride.

The stride in the stride processing can be changed. For example, the activation/stride processing unit 407 may perform processing using two or more types of strides (e.g., R=1, and any desired value other than R=1). In this case, the stride may be set for each layer of the neural network. For example, in one embodiment, the stride when performing the pooling operations is greater than 1. Additionally, in one embodiment, the stride processing is performed by the activation/stride processing unit 407 even when the convolution operations is performed. However, in one embodiment, the stride in the stride processing is 1 when performing the convolution operations.

In this manner, the activation/stride processing unit 407 can output the result of the convolution operations or the pooling operations on the basis of the data stored by the result holding unit 504. In the present embodiment, the activation/stride processing unit 407 is a hardware circuit. The activation/stride processing unit 407 may be referred to herein as an “activation processing circuit” or a “stride processing circuit”. However, a combination of a circuit that performs the activation processing and a circuit that performs the stride processing may be used instead of the activation/stride processing unit 407. Additionally, at least one of the activation processing and the stride processing may be performed by the controller 401 or the CPU 306.

A processing method performed by the convolution operation unit 305 will be described next with reference to FIGS. 1A and 1B. In step S101, the controller 401 reads out a plurality of input images, the weights used in the convolution operations, and the network structure information from the RAM 308, and stores those items in the data holding unit 408. The controller 401 may read out feature data of feature images, such as the feature image obtained through processing in the neural network, from the RAM 308, and store that feature data in the data holding unit 408.

In step S102, a loop performed for each layer starts. In the processing according to FIGS. 1A and 1i, the first layer (layer 1) can be selected first. In this case, layer 1 is the current layer that is to be processed.

In step S103, the controller 401 sets the convolution operations or filter processing in accordance with the network structure information held in the data holding unit 408. In this example, the network structure information instructs convolution operations to be performed to generate the feature image of layer 1. As such, if the current layer is layer 1, the controller 401 can set the convolution operations. The network structure information also instructs pooling operations to be performed to generate the feature image of layer 2. As such, if the current layer is layer 2, the controller 401 can set the filter processing.

In step S104, a loop is started for each pixel in an output feature image. The output feature image corresponds to each of the plurality of feature images in the current layer. The following will describe processing for calculating the feature data of a pixel (i, j) in an nth feature image in the current layer. By repeating such processing, the feature data for each pixel in the output feature image is calculated in order. In addition, by performing such processing on each feature image in the current layer, a plurality of feature images for the current layer are generated.

In step S105, the controller 401 initializes the processing result held in the adding/comparison processing unit 403. The controller 401 can perform this initialization by setting the value held by the result holding unit 504 (described later) to zero.

In step S106, a loop for each of input feature images is started. The input feature image is the feature image of the layer previous to the current layer, used to calculate the feature data of each pixel in the output feature image. When performing the convolution operations, the output of a single channel can be generated on the basis of the inputs of a plurality of channels. Accordingly, when the convolution operations are set in step S103, each of the plurality of feature images in the previous layer (e.g., feature images (1, 1) to (1, 3)) can be used to calculate the feature data of each pixel in the output feature image (e.g., a feature image (2, 1)). For this reason, the loop using each of the plurality of feature images in the previous layer is repeated. On the other hand, in the case of pooling operations (e.g., max pooling or average pooling), the output result of one channel is generated on the basis of the input of one channel. Accordingly, when the pooling operations are set in step S103, one feature image in the previous layer (e.g., the feature image (2, 1)) is used to calculate the feature data of each pixel in the output feature image (e.g., a feature image (3, 1)). For this reason, there is only one input feature image, and the loop is therefore performed once. A case where processing using the mth feature image of the previous layer is performed will be described below.

In step S107, the controller 401 reads out some of the feature data of the input feature image, which is to be used in the processing performed in step S108, from the data holding unit 408, and transfers that data to the feature data holding unit 402. For example, the controller 401 can transfer feature data (I_{i-(X-1)/2, j-(Y-1)/2}(m) to I_{i+(X-1)/2,j+(Y-1)/2}(m)) in the window of the convolution operations. The controller 401 also reads out some of the weights to be used in the processing performed in step S108 from the data holding unit 408 and transfers those weights to the filter weight holding unit 404. For example, the controller 401 can transfer the weight C_{x,y}(m, n) to the filter weight holding unit 404.

In step S108, the filter weight setting unit 405 sets a plurality of filter weights used by the adding/comparison processing unit 403. The filter weight setting unit 405 can set the filter weights according to a control signal from the controller 401. The filter weight setting unit 405 can set a weight C′_{x,y}(m, n) according to Formula (5). In the present embodiment, the filter weight setting unit 405 sets the weight C′ according to whether to perform max pooling, average pooling, or convolution. As described above, the filter weight setting unit 405 may set the weight C′_{x,y}(m, n) by adjusting the weight C_{x,y}(m, n) held by the filter weight holding unit 404.

$${C}_{x , y}^{′} ( m , n ) = \{ \begin{matrix}1 , & Max pooling \\ \frac{1}{XY} , & Average pooling \\ {C}_{x , y} ( m , n ) , & Convolution\end{matrix} \qquad ( 5 )$$

The bit width of the input data input to the adding unit 501 and the comparison unit 502 can be set in accordance with the range of the values of the weights. In the case of max pooling, the weight C′_{x, y}(m, n) is 1, and the range of values is smaller than the weight C_{x,y}(m, n) in the case of the convolution operations. As such, the values do not change even if some bits are discarded. The circuit scale can be reduced by reducing the bit width of C′_{x, y}(m, n) input to the comparison unit 502.

Note that when performing the pooling operations, the weight C′_{x, y}(m, n) may be set as follows. If n=m, the weight C′_{x, y}(m, n)=1 (max pooling) or 1/XY (average pooling). If n m, the weight C′_{x,y}(m, n)=0. Using such weights makes it possible to use the same loop processing for each input feature image, starting from step S106, both for when pooling operations are set and when convolution operations are set. In other words, in this case, the loop using each of the plurality of feature images in the previous layer is repeated even if pooling operations are set. When n m, the loop processing can also be omitted in order to reduce the processing time.

In step S109, the multiplication processing unit 406 performs a multiplication operation on the input feature data I(m) held by the feature data holding unit 402 and the weight C′_{x,y}(m, n) held by the filter weight holding unit 404. Here, the multiplication processing unit 406 sequentially outputs results of multiplying each of the plurality of items of feature data with a corresponding weight. Specifically, the multiplication processing unit 406 can output the product of the feature data I_{i+x-(x-1)/2,j+y-(Y-1)/2}(m) and the corresponding weight C′_{x,y}(m, n).

In addition, the adding/comparison processing unit 403 integrates the multiplication results sequentially output by the multiplication processing unit 406, or selects one of the multiplication results sequentially output by the multiplication processing unit 406, in accordance with a control signal from the controller 401. The output of the adding/comparison processing unit 403 can be expressed by Formula (6), for example.

$$f ( {I}_{i , j} ( m ) , {C}_{x , y}^{′} ( m , n ) ) = \{ \begin{matrix}{\sum }_{x = 0}^{X - 1} {\sum }_{y = 0}^{Y - 1} ( {I}_{i - \frac{X - 1}{2} + x , j - \frac{Y - 1}{2} + y} ( m ) \times {C}_{x , y}^{′} ( m , n ) ) , & Convolution or Average pooling \\ {max}_{0 \leq x < X} {max}_{0 \leq y < Y} ( {I}_{i - \frac{X - 1}{2} + x , j - \frac{Y - 1}{2} + y} ( m ) \times {C}_{x , y}^{′} ( m , n ) ) , & Max pooling\end{matrix} \qquad ( 6 )$$

X and Y indicate the window size of the filter used in the convolution operations or the filter used in the filter processing. When the window size is 3×3, X is 3 and Y is 3.

As described earlier, in response to an instruction to perform convolution operations to generate the feature image, the multiplication processing unit 406 sequentially outputs results of multiplying each of the plurality of items of data in the window for the convolution operations with a corresponding convolution filter weight. The convolution filter weight is a weight C_{x,y}(m, n) for convolution operations. In this case, the selection unit 503 outputs the output of the adding unit 501 to the result holding unit 504.

Additionally, in response to an instruction to perform average pooling to generate the feature image, the multiplication processing unit 406 sequentially outputs results of multiplying each of the plurality of items of data in the window for the average pooling with the same filter weight. The filter weight is 1/XY In this case, the selection unit 503 outputs the output of the adding unit 501 to the result holding unit 504.

Additionally, in response to an instruction to perform max pooling to generate the feature image, the multiplication processing unit 406 sequentially outputs results of multiplying each of the plurality of items of data in the window for the max pooling with the same convolution filter weight. The filter weight is 1. In this case, the selection unit 503 outputs the output of the comparison unit 502 to the result holding unit 504.

The processing of step S109 can be performed according to the details indicated in steps S115 to S121. In step S115, a loop performed for each item of feature data is started. This loop can be performed for each item of the feature data (I_{i-(X-1)/2, j-(Y-1)/2}(m) to I_{i+(X-1)/2, j+(Y-1)/2}(m)) of the input feature image. Specifically, the following loop can be performed for each combination of x(0 to X−1) and y(0 to Y−1).

In step S116, the multiplication processing unit 406 outputs the result of multiplying the feature data I_{i+x-(x-1)/2, j+y-(Y-1)/2}(m) with the corresponding weight C′_{x, y}(m, n).

In step S117, the controller 401 selects an accumulation operation or comparison processing on the basis of the network structure information held in the data holding unit 408. When performing convolution operations or average pooling to generate the feature image of the current layer, the controller 401 selects the accumulation operation. In this case, the sequence moves to step S118. When not performing such processing, however, the controller 401 selects the comparison processing. In this case, the sequence moves to step S119.

In step S118, the adding/comparison processing unit 403 performs adding processing. In other words, the adding unit 501 outputs the sum of the output of the multiplication processing unit 406 and the output of the result holding unit 504 as described above. The controller 401 also controls the selection unit 503 to select the output of the adding unit 501. Then, the sequence moves to step S120.

In step S119, the adding/comparison processing unit 403 performs comparison processing. In the present embodiment, the comparison unit 502 selects the greater of the output of the multiplication processing unit 406 and the output of the result holding unit 504. The controller 401 also controls the selection unit 503 to select the output of the comparison unit 502. Then, the sequence moves to step S120.

In step S120, the processing result held in the result holding unit 504 is replaced with the processing result selected by the selection unit 503.

In step S121, the loop performed for each item of feature data ends. As a result, if the controller 401 has selected the accumulation operation, the multiplication result output in step S116 is accumulated in the result holding unit 504. If the controller 401 has selected the comparison operation, the largest of the multiplication results output in step S116 after the initialization of the result holding unit 504 is stored in the result holding unit 504.

In step S110, the controller 401 determines whether the loop for each of the input feature images has ended. If the processing has ended for all of the input feature images used to calculate the feature data of each pixel in the output feature image, the sequence moves to step S111. If not, the sequence returns to step S107. The processing for the next input feature image then starts.

When step S110 ends, the result holding unit 504 of the adding/comparison processing unit 403 stores the result of the convolution operations or filter processing corresponding to the pixel (i, j) in the nth feature image of the current layer. Specifically, the value O_{i,j}(n) indicated in Formula (7) is stored in the result holding unit 504. The variable M indicates the number of input feature images used to calculate the feature data of each pixel in the output feature image. When performing convolution operations, M is any desired positive integer. In this case, the result of Formula (7) is the same as the result of Formula (1). When performing the pooling operations, the weight for m≠n is zero, leading to the same as the result of assigning n to m in Formula (6). In this case, the result of Formula (7) is the same as the result of Formula (2) or (3). In this manner, the result of the convolution operations or filter processing can be obtained through steps S106 to S110.

$${O}_{i , j} ( n ) = {\sum }_{m = 1}^{M} f ( {I}_{i , j} ( m ) , {C}_{xy ,}^{′} ( m , n ) ) \qquad ( 7 )$$

In step S111, the activation/stride processing unit 407 can perform processing on the data output by the adding/comparison processing unit 403 in accordance with a control signal from the controller 401. For example, the activation/stride processing unit 407 can perform activation processing on the convolution operations result stored in the result holding unit 504 in accordance with the network structure information. Specifically, the activation/stride processing unit 407 can perform activation processing according to Formula (8).

$$a ( x ) = \{ \begin{matrix}0 , & x < 0 \\ x , & x \geq 0\end{matrix} \qquad ( 8 )$$

In Formula (8), a(·) represents an activation function. x represents the input data. In this example, the activation processing is performed using a Rectified Linear Unit (ReLU). However, the type of the activation processing is not particularly limited. For example, another nonlinear function or a quantization function may be used.

In addition, the activation/stride processing unit 407 can perform stride processing on the convolution operations result stored in the result holding unit 504. The controller 401 can control the stride of the stride processing in accordance with the network structure information. For example, the controller 401 can set the stride of the stride processing to 1 in response to an instruction to perform the convolution operations for generating the feature image.

Additionally, the controller 401 can set the stride of the stride processing to 2 or higher in response to an instruction to perform the pooling operations for generating the feature image. The activation/stride processing unit 407 may extract the pixels of the feature image at equal intervals in a spatial direction in accordance with the network structure information. For example, the activation/stride processing unit 407 can adjust the size of the output feature image by calculating the stride processing result according to Formula (4). Specifically, if the pixel (i, j) is not the pixel to be extracted, the activation/stride processing unit 407 may discard the convolution operations result held in the result holding unit 504.

Note that the activation/stride processing unit 407 does not absolutely need to perform the activation processing or stride processing. The activation/stride processing unit 407 can perform these processes as necessary. The activation/stride processing unit 407 may also perform both the activation processing and the stride processing in a single layer. The activation processing or the stride processing may also be performed after the loop for all the pixels in one output feature image has ended, or after the loop for all the pixels in all the output feature images has ended.

In step S112, the controller 401 stores the processing result from the activation/stride processing unit 407 (or the output from the adding/comparison processing unit 403) in the feature data holding unit 402. The data stored in the feature data holding unit 402 can be handled as feature data of the pixel (i, j) in the feature image m of the current layer.

In step S113, the controller 401 determines whether the loop for each pixel in the output feature image has ended. If the processing has ended for all the pixels in all the output feature images, the sequence moves to step S114. At this time, a plurality of feature images of the current layer are stored in the feature data holding unit 402. If not, however, the sequence returns to step S105. In this case, the processing for the pixels in the next output feature image starts.

In this example, the result of the convolution operations or the result of the filter processing used in the pooling operations is obtained for each of a plurality of windows set in the feature image of the previous layer such that the stride is 1. The controller 401 controls the multiplication processing unit 406 and the selection unit 503 to obtain such a result. Specifically, the controller 401 can control the supply of the feature data to the multiplication processing unit 406 to obtain such a result.

In step S114, the controller 401 determines whether the loop for each layer has ended. If the processing for all of the layers has ended, the controller 401 writes the feature image of the final layer held by the feature data holding unit 402 into the RAM 308. This ends the processing in the neural network. If not, however, the sequence returns to step S103. In this case, the layer to be processed is changed, and the processing for the next layer is started.

According to the embodiment described above, the pooling operations are divided into filter processing and stride processing. The convolution operations and the filter processing are then performed using a common computation circuit (the convolution operation unit 305). As a result, the processing can be performed efficiently while suppressing an increase in the circuit scale.

In this manner, in one embodiment, the result holding unit 504 holds the output result from the adding unit 501 or the comparison unit 502. This makes it possible to reduce the circuit scale of the convolution operation apparatus, which can perform both convolution operations and pooling operations. Additionally, in one embodiment, the shared feature data holding unit 402 holds the data used in the convolution operations and the pooling operations. This makes it possible to improve the efficiency of the convolution operations and the pooling operations with a small circuit scale, compared to a configuration in which the convolution operations and the pooling operations are performed by different computation devices. Furthermore, according to the present embodiment, the window size and the stride in the pooling operations can be set to different values. For this reason, the convolution operation apparatus according to the present embodiment has an advantage in that a wide variety of networks can be supported.

In the foregoing embodiment, the filter weight setting unit 405 sets the filter weights according to Formula (5). However, the filter weights according to Formula (5) may be prepared before performing the neural network processing. For example, in step S101, the controller 401 may read out the weights from the RAM 308, adjust the weights according to Formula (5), and store the adjusted weights in the data holding unit 408. Additionally, the adjusted weights may be stored in the RAM 308 prior to the start of the processing according to FIGS. 1A and 1B. For example, the CPU 306 may store the weights according to Formula (5) in the RAM 308. In this case, in step S107, the controller 401 can read out the adjusted weights from the data holding unit 408 and transfer those weights to the feature data holding unit 402. In addition, the processing of step S108 can be omitted. According to such a configuration, the convolution operation unit 305 need not include the filter weight setting unit 405. This makes it possible to further reduce the circuit scale of the convolution operation unit 305.

### Variation

The convolution operation unit 305 described above can perform other filter processing aside from the convolution operations and the pooling operations on images. By controlling the weights supplied to the multiplication processing unit 406, the operations of the selection unit 503, and the like, various types of filter processing can be implemented.

Post-processing may be performed on the results of the neural network processing using the convolution operation unit 305 described above. In other words, the convolution operation unit 305 can perform further filter processing on images obtained through convolution operations or pooling operations on images. For example, as described above, the information processing apparatus can generate a confidence map (the feature image 204) using the convolution operation unit 305. Additionally, the information processing apparatus may perform peak value detection processing on the feature image 204. For example, the information processing apparatus can set all pixel values other than the peak values in the feature image 204 to zero. In this manner, the information processing apparatus can delete duplicate detection results in the feature image 204. In the present variation, such peak value detection processing is performed efficiently by using the convolution operation unit 305 used in the neural network processing.

The convolution operation unit 305 may perform part of the post-processing. In the following example, the convolution operation unit 305 performs part of the peak value detection processing. Specifically, the convolution operation unit 305 can apply a maximum value filter to a feature image A901 in accordance with Formula (2). In addition, another processing unit, such as the CPU 306, performs at least part of the processing using the image obtained through the convolution operations or the pooling operations performed on the image. In this example, the CPU 306 performs the remainder of the peak value detection processing.

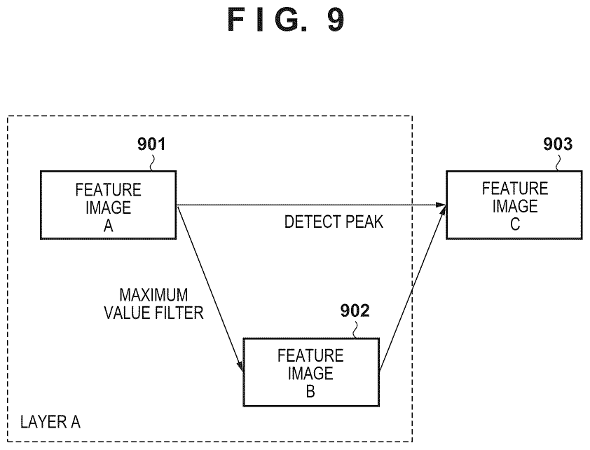

FIG. 9 illustrates an example of the structure of a neural network used to perform the peak value detection processing. The number of layers in this network is 1. The network has layer A. Layer A has one feature image. The single feature image contains a plurality of items of feature data (e.g., confidence levels) as pixel values. In layer A, a feature image B902 is generated by applying a maximum value filter to the feature image A901. Then, a feature image C903 indicating the result of the peak detection processing is generated by referring to the feature image A901 and the feature image B902.

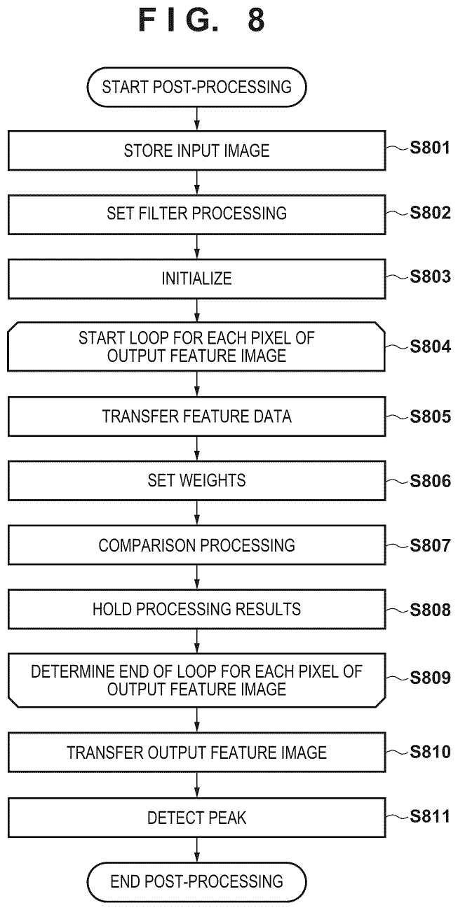

FIG. 8 is a flowchart illustrating post-processing according to the present variation. Steps S801 to S810 correspond to part of the processing illustrated in FIGS. 1A and 1B. This means that the processing illustrated in FIG. 8 can be performed using the convolution operation unit 305. The feature image A901 can be generated through the processing described with reference to FIGS. 1A and 1B.

In step S801, the controller 401 reads out the feature image A901, the weights, and the network structure information from the RAM 308, and stores that information in the data holding unit 408. However, the weights read out from the RAM 308 are not used in the post-processing described here. As such, the controller 401 can store any desired weights in the data holding unit 408.

In step S802, the controller 401 sets the filter processing in accordance with the network structure information held in the data holding unit 408.

In step S803, the controller 401 initializes the processing result held in the adding/comparison processing unit 403, in the same manner as in step S105.

In step S804, a loop is started for each pixel in an output feature image. In this example, the output feature image is the feature image B902. The following will describe processing for calculating the feature data of a pixel (i, j) in an nth feature image in the current layer. By repeating such processing, the feature data for each pixel in the output feature image is calculated in order.

In step S805, the controller 401 reads out some of the feature data of the input feature image, which is to be used in the processing performed in step S806, from the data holding unit 408, and transfers that data to the feature data holding unit 402, in the same manner as in step S107. The controller 401 also reads out the weights from the data holding unit 408 and transfers those weights to the filter weight holding unit 404.

In step S806, the filter weight setting unit 405 sets a plurality of filter weights used by the adding/comparison processing unit 403. In this example, the filter weight setting unit 405 adjusts the weights according to Formula (9).

$${C}_{x , y}^{′} ( m , n ) = 1 \qquad ( 9 )$$

In step S807, the multiplication processing unit 406 performs a multiplication operation for multiplying the input feature data I(m) held by the feature data holding unit 402 with the weight C′_{x,y}(m, n) held by the filter weight holding unit 404, in the same manner as in step S109. In addition, the adding/comparison processing unit 403 outputs the maximum of the multiplication results sequentially output by the multiplication processing unit 406, in the same manner as in S109. In other words, the selection unit 503 outputs the output of the comparison unit 502 to the result holding unit 504. In this example, the window size is 3×3.

In step S808, the controller 401 stores the output from the adding/comparison processing unit 403 in the feature data holding unit 402. The data stored in the feature data holding unit 402 can be handled as feature data of the pixel (i, j) in the feature image B902.

In step S809, the controller 401 determines whether the loop for each pixel in the output feature image has ended. If the processing has ended for all the pixels in the output feature image, the sequence moves to step S810. At this time, the feature image B902 is stored in the feature data holding unit 402 as the output feature image. If not, however, the sequence returns to step S805. In this case, the processing for the next pixel in the output feature image starts.

In step S810, the controller 401 writes the feature image B902 held in the feature data holding unit 402 into the RAM 308.

In step S811, the CPU 306 reads out the feature image A901 and the feature image B902 held by the RAM 308. The CPU 306 then calculates the feature image C903 in accordance with Formula (10). In step S811, the CPU 306, which is a general-purpose processor, performs processing different from the convolution operations and the filter processing.

$${IC}_{i , j} = \{ \begin{matrix}{IA}_{i , j} , & if {IA}_{i , j} = {IB}_{i , j} \\ 0 , & otherwise\end{matrix} \qquad ( 10 )$$

In Formula (10), IC represents the feature image C903. IA represents the feature image A901 from before the filter processing. The variable IB represents the feature image B902 from after the filter processing. The variable i, j represents coordinates in the feature image. Finally, the CPU 306 stores the obtained feature image C903 in the RAM 308. The post-processing ends in this manner.

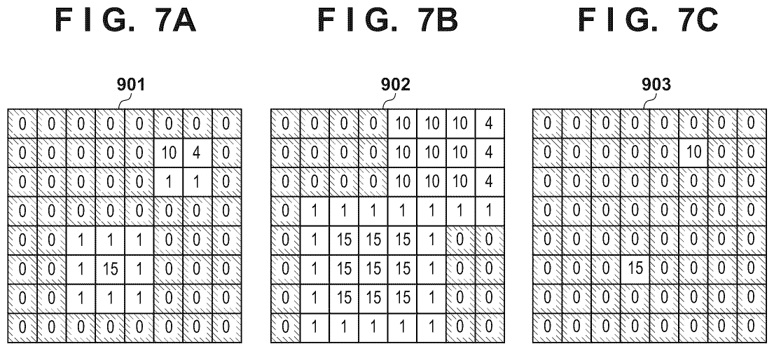

FIGS. 7A to 7C illustrate an example of the post-processing. In FIGS. 7A to 7C, pixels having a value of zero are represented by black. The feature image A901 has an image size of 8×8. The feature image B902 obtained as described above corresponds to a result obtained by applying a 3×3 maximum value filter to the feature image A901. Two pixels having pixel values greater than the surrounding pixels (having values of 10 and 15) in the feature image A901 are indicated in the feature image C903. These pixels are treated as peaks. Here, “peak” refers to a pixel having a maximum value within a 3×3 pixel range.

In the present variation, part of the peak detection processing is performed using the convolution operation unit 305. This makes it possible to increase the processing speed as compared to the case where the CPU 306 performs all the peak detection processing. On the other hand, performing the post-processing using the convolution operation unit 305 used for the convolution operations makes it possible to reduce the scale of the circuit as compared to the case where a dedicated circuit for the post-processing is provided.

### OTHER EMBODIMENTS

In the foregoing embodiment, the stride is represented by one variable R. However, it is not necessary to represent the stride using a single variable. For example, the stride may be represented by two variables, as indicated by Formula (11).

$${O}_{i , j}^{″} ( m ) = {O}_{R \times i , S \times j}^{′} ( m ) \qquad ( 11 )$$

In Formula (11), the variable R represents the stride in the horizontal direction, and the variable S represents the stride in the vertical direction. In this case, the size (number of pixels) of the feature image after the stride processing is 1/(R×S) from before the processing. A stride greater than 1 as referred to herein means that at least one of the variables R and S is greater than 1.

Additionally, the types of the pooling operations are not limited to max pooling and average pooling. For example, the convolution operation unit 305 may perform min pooling. Formula (12) expresses min pooling. The window size is X×Y.

$${O}_{i , j}^{′} ( n ) = {min}_{0 \leq x < X} {min}_{0 \leq y < Y} ( {I}_{i - \frac{X - 1}{2} + x , j - \frac{Y - 1}{2} + y} ( n ) ) \qquad ( 12 )$$

When performing min pooling, the comparison unit 502 of the adding/comparison processing unit 403 outputs the smaller of the output of the multiplication processing unit 406 and the output of the result holding unit 504, rather than the greater of the outputs. In step S105, the controller 401 can perform initialization by setting the value held by the result holding unit 504 to the theoretical maximum value of the output of the multiplication processing unit 406 (2^{X}−1 in the case of unsigned X bits). The other processing is the same as when performing max pooling. The convolution operation unit 305 can apply a minimum value filter to a feature image.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-204128, filed Dec. 1, 2023, which is hereby incorporated by reference herein in its entirety.

What is claimed is:

1. A processing apparatus comprising:
a multiplier circuit configured to sequentially output a multiplication result obtained by multiplying each of a plurality of items of data with a corresponding filter weight;
a memory;
an adding circuit configured to add the multiplication result output by the multiplier circuit with data held in the memory and output an adding result;
a comparison circuit configured to compare the multiplication result output by the multiplier circuit with the data held in the memory, and output one of the multiplication result output by the multiplier circuit and the data held in the memory; and
a selection circuit configured to output, to the memory, one of the output from the adding circuit and the output from the comparison circuit to be held in the memory.

2. The processing apparatus according to claim 1,
wherein the selection circuit is further configured to repeat, for each of the plurality of items of data, an operation of outputting one of the output from the adding circuit and the output from the comparison circuit to the memory, and
after the selection circuit has repeated the operation of outputting for each of the plurality of items of data, the data held in the memory is output as a processing result of processing performed on the plurality of items of data.

3. The processing apparatus according to claim 1, further comprising:
an activation processing circuit configured to perform activation processing on the data held in the memory.

4. The processing apparatus according to claim 1,
wherein the processing apparatus is further configured to be capable of performing convolution operations and pooling operations on an image,
the multiplier circuit is further configured to sequentially output a multiplication result of multiplying each of a plurality of items of data included in a window of the convolution operations or the pooling operations set in the image with a corresponding filter weight,
the selection circuit is further configured to repeat, for each of the plurality of items of data, an operation of outputting one of the output from the adding circuit and the output from the comparison circuit to the memory, and
after the selection circuit has repeated the operation of outputting for each of the plurality of items of data, the memory outputs the data held in the memory as a result of the convolution operation or a result of filter processing for the pooling operation on the window.

5. The processing apparatus according to claim 4,
wherein the processing apparatus is further configured to be capable of performing at least two types of pooling operations.

6. The processing apparatus according to claim 4,
wherein the data output from the memory corresponds to pixel data of an image indicating a result of the convolution operation or the filter processing performed on the image, and
the processing apparatus further comprising:
a stride processing circuit configured to perform stride processing that extracts part of the data output from the memory to reduce the image according to a predetermined stride.

7. The processing apparatus according to claim 6,
wherein the processing apparatus is configured to be capable of changing the stride.

8. The processing apparatus according to claim 6,
wherein when performing the pooling operations, a size of the window is greater than 1×1, and the stride is greater than 1.

9. The processing apparatus according to claim 6,
wherein the processing apparatus is further configured to perform processing in a neural network, and
the stride is set for each of layers in the neural network.

10. The processing apparatus according to claim 6, further comprising:
a controller, the controller configured to:
control the multiplier circuit and the selection circuit to output the result of the convolution operation or the result of the filter processing for the pooling operation for each of a plurality of windows set in the image such that the stride is 1;
set the stride of the stride processing to 1 in response to an instruction to perform the convolution operations; and
set the stride of the stride processing to at least 2 in response to an instruction to perform the pooling operations.

11. The processing apparatus according to claim 4, further comprising:
a setting unit configured to set the filter weight corresponding to each of the plurality of items of data in accordance with which of the convolution operations or the pooling operations are to be performed on the image.

12. The processing apparatus according to claim 4,
wherein in response to an instruction to perform the convolution operations,
the multiplier circuit is further configured to sequentially output a multiplication result of multiplying each of the plurality of items of data in the window of the convolution operations with the corresponding filter weight, and
the selection circuit is further configured to output the output from the adding circuit to the memory.

13. The processing apparatus according to claim 4,
wherein in response to an instruction to perform average pooling,
the multiplier circuit is further configured to sequentially output a multiplication result of multiplying each of the plurality of items of data in a window of the average pooling with a same filter weight, and
the selection circuit is further configured to output the output from the adding circuit to the memory.

14. The processing apparatus according to claim 4,
wherein in response to an instruction to perform max pooling or min pooling,
the multiplier circuit is further configured to sequentially output a multiplication result of multiplying each of the plurality of items of data in a window of the max pooling or the min pooling with a same filter weight, and
the selection circuit is further configured to output the output from the comparison circuit to the memory.

15. The processing apparatus according to claim 4,
wherein the processing apparatus is further configured to be capable of performing filter processing aside from the convolution operations and the pooling operations on the image, and
the processing apparatus is further configured to perform the filter processing on an image obtained by performing the convolution operations or the pooling operations on the image.

16. The processing apparatus according to claim 4, further comprising:
a processor configured to perform at least part of processing which uses an image obtained by performing the convolution operations or the pooling operations on the image.

17. The processing apparatus according to claim 16,
wherein the processing which uses the image is peak detection processing.

18. The processing apparatus according to claim 1,
wherein the processing apparatus is further configured to perform processing in a neural network, and
the selection circuit is further configured to output, to the memory, one of the output from the adding circuit and the output from the comparison circuit, the output being selected for each of layers in the neural network.

19. The processing apparatus according to claim 18,
wherein the selection circuit is further configured to output, to the memory, one of the output from the adding circuit and the output from the comparison circuit, the output being selected in accordance with a type of processing performed in each of the layers.

20. A processing apparatus configured to be capable of performing convolution operations and pooling operations, the processing apparatus comprising:
a setting unit configured to set a plurality of filter weights in accordance with which of the convolution operations or the pooling operations are to be performed;
a multiplier circuit configured to sequentially output a multiplication result obtained by multiplying each of a plurality of items of data with a corresponding filter weight;
a memory configured to hold data indicating an accumulation result of each of multiplication results output by the multiplier circuit, or a multiplication result selected from the multiplication results; and
an output unit configured to output a result of the convolution operation or the pooling operation on the basis of data stored in the memory.
